(19) United States
(12) Patent Application Publication
(10) Pub. No.: US 2025/0039866 A1
(43) Pub. Date: Jan. 30, 2025

(54) RESOURCE SCHEDULING METHOD AND SYSTEM

(71) Applicant: SHANGHAI BILIBILI TECHNOLOGY CO., LTD., Shanghai (CN)

(72) Inventor: Junxing TANG, Shanghai (CN)

(21) Appl. No.: 18/715,724

(22) PCT Filed: Jun. 17, 2022
(86) PCT No.: PCT/CN2022/099474

§ 371 Date: Jun. 2, 2024

(30) Foreign Application Priority Data
Dec. 2, 2021 (CN) 202111462120.X

(51) Int. Cl. H04W 72/1263; H04W 76/18

(52) U.S. Cl. CPC H04W 72/1263; H04W 76/18

(57) ABSTRACT

Embodiments of the present application provide a resource scheduling method and system. The resource scheduling method includes: receiving a resource scheduling request, where the resource scheduling request carries a target request domain name and terminal address information of a client device; determining, based on the terminal address information, an edge acceleration node corresponding to the target request domain name and a scheduling parameter of the edge acceleration node; generating node address information of the edge acceleration node based on processing the target request domain name and the scheduling parameter of the edge acceleration node according to a target scheduling protocol; returning the node address information to the client device, where the client device performs resource scheduling on the edge acceleration node to obtain a corresponding resource scheduling result based on the node address information.

The present application claims priority to Chinese Patent Application No. 202111462120.X, filed with the China National Intellectual Property Administration on Dec. 2, 2021, and entitled “RESOURCE SCHEDULING METHOD AND SYSTEM”, which is incorporated herein by reference in its entirety.

### TECHNICAL FIELD

Embodiments of the present application relate to the field of computer technologies, and in particular, to a resource scheduling method. One or more embodiments of the present application further relate to a resource scheduling system, a resource scheduling apparatus, a computing device, a computer-readable storage medium, and a computer program.

### BACKGROUND ART

With the development of technology, the definition and smoothness of video services are constantly improved. Moreover, with the advent of the Internet era, the demand of users for high-quality videos is increasingly high. Currently, high-definition videos have become mainstream. The improvement in resolution and definition has enhanced the viewing experience of users; however, it has also led to a significant increase in traffic usage.

Currently, the prevailing video distribution method in the industry is to deploy videos/audio/images and other resources in a content delivery network (CDN). When users want to download resources, they directly initiate resource requests to the CDN, thereby enabling downloads, live streaming, and on-demand streaming. The users can also request resources from other users, enabling resource sharing through peer-to-peer (P2P) technology. The core working mode of a peer-to-peer content delivery network (PCDN) system is to first cache media content on home Internet devices, and then allow client devices to be connected with these devices in a P2P manner to retrieve data.

However, in the current content delivery process, a software development kit (SDK) is usually required for PCDN scheduling. In this case, corresponding SDKs need to be provided for different vendors, which requires extensive SDK development and adaptation, resulting in inefficient resource scheduling. Therefore, there is an urgent need for an effective resource scheduling method to solve these problems.

### SUMMARY OF THE INVENTION

In view of this, an embodiment of the present application provides a resource scheduling method. One or more embodiments of the present application further relate to a resource scheduling system, a resource scheduling apparatus, a computing device, a computer-readable storage medium, and a computer program, so as to overcome the technical defect that in the prior art, in the process of implementing PCDN scheduling through an SDK, extensive development and adaptation are required to provide corresponding SDKs for different vendors, resulting in inefficient resource scheduling.

According to a first aspect of an embodiment of the present application, a resource scheduling method is provided. The resource scheduling method is applied to a scheduling center, and includes:
receiving a resource scheduling request, where the resource scheduling request carries a target request domain name and terminal address information of a client device;
determining, according to the terminal address information, an edge acceleration node corresponding to the target request domain name and a scheduling parameter of the edge acceleration node; and
processing the target request domain name and the scheduling parameter according to a target scheduling protocol, generating node address information of the edge acceleration node, and returning the node address information to the client device, where the client device performs, based on the node address information, resource scheduling on the edge acceleration node to obtain a corresponding resource scheduling result.

According to a second aspect of an embodiment of the present application, a resource scheduling system is provided. The resource scheduling system includes: a client device and a scheduling center.

The client device is configured to send a first resource scheduling request to the scheduling center, where the first resource scheduling request carries a target request domain name and terminal address information of the client device.

The scheduling center is configured to determine, according to the terminal address information, a first edge acceleration node corresponding to the target request domain name and a scheduling parameter of the first edge acceleration node, process the target request domain name and the scheduling parameter according to a target scheduling protocol, and generate and return node address information.

The client device is further configured to acquire the node address information, and perform resource scheduling on the first edge acceleration node based on the node address information to obtain a corresponding resource scheduling result.

According to a third aspect of an embodiment of the present application, another resource scheduling method is provided. The resource scheduling method is applied to a client device, and includes:
sending a resource scheduling request to a scheduling center, where the resource scheduling request carries a target request domain name and terminal address information of the client device;
acquiring node address information of an edge acceleration node returned by the scheduling center, where the scheduling center determines, according to the terminal address information, an edge acceleration node corresponding to the target request domain name and a scheduling parameter of the edge acceleration node, processes the target request domain name and the scheduling parameter according to a target scheduling protocol, and generates the node address information; and
performing resource scheduling on the edge acceleration node based on the node address information to obtain a corresponding resource scheduling result.

According to a fourth aspect of an embodiment of the present application, a resource scheduling apparatus is provided. The resource scheduling apparatus includes:
a receiving module, configured to receive a resource scheduling request, where the resource scheduling request carries a target request domain name and terminal address information of a client device;
a determining module, configured to determine, according to the terminal address information, an edge acceleration node corresponding to the target request domain name and a scheduling parameter of the edge acceleration node; and
a processing module, configured to process the target request domain name and the scheduling parameter according to a target scheduling protocol, generate node address information of the edge acceleration node, and return the node address information to the client device, where the client device performs, based on the node address information, resource scheduling on the edge acceleration node to obtain a corresponding resource scheduling result.

According to a fifth aspect of an embodiment of the present application, another resource scheduling apparatus is provided. The resource scheduling apparatus includes:
a sending module, configured to send a resource scheduling request to a scheduling center, where the resource scheduling request carries a target request domain name and terminal address information of a client device;
an acquiring module, configured to acquire node address information of an edge acceleration node returned by the scheduling center, where the scheduling center determines, according to the terminal address information, an edge acceleration node corresponding to the target request domain name and a scheduling parameter of the edge acceleration node, processes the target request domain name and the scheduling parameter according to a target scheduling protocol, and generates the node address information; and
a scheduling module, configured to perform resource scheduling on the edge acceleration node based on the node address information to obtain a corresponding resource scheduling result.

According to a sixth aspect of an embodiment of the present application, a computing device is provided. The computing device includes:
a memory and a processor.

The memory is configured to store computer executable instructions. The processor is configured to execute the computer executable instructions. The processor, when executing the computer executable instructions, implements the steps of the resource scheduling method.

According to a seventh aspect of an embodiment of the present application, a computer-readable storage medium is provided. The computer-readable storage medium stores computer executable instructions. When the instructions are executed by a processor, the steps of the resource scheduling method are implemented.

According to an eighth aspect of an embodiment of the present application, a computer program is provided. The computer program, when executed in a computer, enables the computer to perform the steps of the foregoing resource scheduling method.

An embodiment of the present application implements a resource scheduling method and system. The resource scheduling method includes receiving a resource scheduling request, where the resource scheduling request carries a target request domain name and terminal address information of a client device; determining, according to the terminal address information, an edge acceleration node corresponding to the target request domain name and a scheduling parameter of the edge acceleration node; and processing the target request domain name and the scheduling parameter according to a target scheduling protocol, generating node address information of the edge acceleration node, and returning the node address information to the client device, where the client device performs, based on the node address information, resource scheduling on the edge acceleration node to obtain a corresponding resource scheduling result.

In this embodiment of the present application, the scheduling center can determine, according to the terminal address information of the client device, an edge acceleration node closer to the client device, then processes the terminal address information of the client device and the scheduling parameter of the edge acceleration node according to the target scheduling protocol, and generates the node address information of the edge acceleration node. The client device can directly acquire the node address information from the scheduling center without the need for an SDK, which is advantageous for reducing the amount of SDK development and improving the efficiency of resource scheduling.

### BRIEF DESCRIPTION OF THE DRAWINGS

FIG. 1 is an architecture diagram of a resource scheduling system according to an embodiment of the present application;

FIG. 2 is a flowchart of a resource scheduling method according to an embodiment of the present application;

FIG. 3 is a flowchart of another resource scheduling method according to an embodiment of the present application;

FIG. 4 is a diagram of a specific flow of a resource scheduling method applied to the video field according to an embodiment of the present application;

FIG. 5 is a schematic diagram of a structure of a resource scheduling apparatus according to an embodiment of the present application;

FIG. 6 is a schematic diagram of a structure of another resource scheduling apparatus according to an embodiment of the present application; and

FIG. 7 is a block diagram of a structure of a computing device according to an embodiment of the present application.

### DETAILED DESCRIPTION OF EMBODIMENTS

In the following description, numerous specific details are set forth to provide a thorough understanding of the present application. However, the present application can be implemented in numerous other ways different from those described herein, and those skilled in the art can make similar extensions without departing from the essence of the present application. Therefore, the present application is not limited by the specific implementations disclosed below.

Terms used in one or more embodiments of the present application are merely for the purpose of describing specific embodiments, and are not intended to limit one or more embodiments of the present application. The terms “a/an”, “said”, and “the” in the singular form used in one or more embodiments of the present application and the appended claims are also intended to include the plural form, unless otherwise clearly indicated in the context. It should also be understood that the term “and/or” used in one or more embodiments of the present application refers to and includes any or all possible combinations of one or more of the associated listed items.

It should be understood that although the terms “first”, “second”, etc. may be used in one or more embodiments of the present application to describe various information, the information should not be limited to these terms. These terms are merely used to distinguish the same type of information from one another. For example, without departing from the scope of one or more embodiments of the present application, “first” may also be referred to as “second”, and similarly, “second” may also be referred to as “first”. Depending on the context, the word “if” as used herein may be interpreted as “when” or “upon” or “in response to determining”.

First, the terms used in one or more embodiments of the present application are explained.

PCDN: a CDN acceleration technology, which differs from a conventional CDN in that the PCDN is deployed on a large number of small nodes, thus achieving cost reduction due to the low cost of the small nodes. Due to a more unreliable network environment of the small nodes, a scheduling program is required to compensate for this.

Scheduling: an important component in a CDN system, which matches healthy playback resources with users by acquiring information about the users and nodes. Behind this, there is typically a comprehensive set of complex health detection and information storage system.

The present application provides a resource scheduling method. One or more embodiments of the present application further relate to a resource scheduling system, a resource scheduling apparatus, a computing device, a computer-readable storage medium, and a computer program, which are described in detail one by one in the following embodiments.

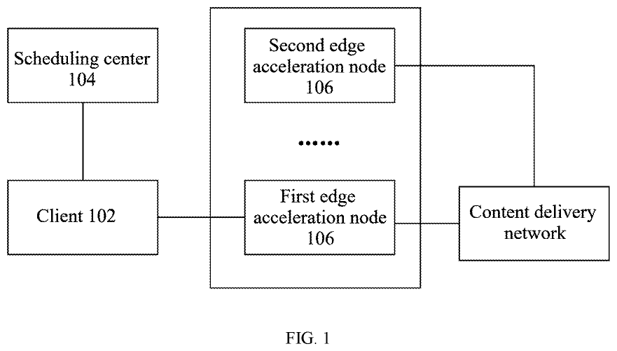

Referring to FIG. 1, FIG. 1 is an architecture diagram of a resource scheduling system according to an embodiment of the present application. The resource scheduling system includes:
a client device 102 and a scheduling center 104.

The client device 102 is configured to send a first resource scheduling request to the scheduling center, where the first resource scheduling request carries a target request domain name and terminal address information of the client device.

The scheduling center 104 is configured to determine, according to the terminal address information, a first edge acceleration node corresponding to the target request domain name and a scheduling parameter of the first edge acceleration node, process the target request domain name and the scheduling parameter according to a target scheduling protocol, and generate and return node address information.

The client device 102 is further configured to acquire the node address information, and perform resource scheduling on the first edge acceleration node based on the node address information to obtain a corresponding resource scheduling result.

The resource scheduling system provided in this embodiment of the present application may further include edge acceleration nodes, namely, a first edge acceleration node 106 and a second edge acceleration node 106.

Specifically, the scheduling center 104 is responsible for receiving a resource scheduling request from the client device 102, returning node information of an edge acceleration node 106 that has resources, and assisting in network address translation between the edge acceleration node 106 and the client device 102.

The edge acceleration node is a PCDN node, which includes an optical modem, a home router, an over-the-top (OTT), or another device operating at the edge of the Internet. The devices run dedicated software, and are deployed and distributed by a network operator. The PCDN node is scheduled by the scheduling center 104 to download and cache specified media data from a content delivery network into limited storage space, and provides the media data to the client device 102 through P2P technology based on a request of a user.

After the client device 102 sends the resource scheduling request to the scheduling center 104, if the client device receives the node address information of the edge acceleration node returned by the scheduling center 104, the client device may download a desired resource from a peer-to-peer content delivery network (PCDN) based on the node address information.

The content delivery network (CDN) is used for deploying resources to be shared, such as videos/audio/images. The CDN may be a virtual network built on an existing network.

When the client device 102 requires a resource download, the client device sends a resource scheduling request to the scheduling center 104. To enable the scheduling center 104 to correctly return information about a PCDN node that has resources to be downloaded, the resource scheduling request may include a target request domain name, as well as terminal address information of the client device 102 and/or resource identification information of a requested resource.

The target scheduling protocol may be the HTTP 302 protocol.

The target request domain name may be used for the client device 102 to initiate a domain name query request to a local DNS server. If the local DNS server has a cache, the local DNS server directly returns the record of the domain name to the client device 102. If the local DNS server does not have a cache, the local DNS server sequentially initiates iterative queries to a root domain and a com domain until the local DNS server finds a name server for a domain of the queried domain name, and then sends a query request to that name server. Since the domain name has been configured with effective CDN rules, the name server provides a CNAME record for the domain name. The CNAME record directs the query request to the scheduling center, namely, the name server responsible for a target request domain. The local DNS server continues to request the record of the domain name from the scheduling center 104. In this case, the scheduling center finds, based on a configuration, that the domain name is configured with HTTP 302 scheduling. According to the target scheduling protocol, a new uniform resource locator (URL) is returned, where the URL includes an IP address of the given PCDN node, namely, the node address information. The client device 102 initiates an HTTP request to the PCDN node according to a result returned by the local DNS server.

Further, after receiving the first resource scheduling request from the client device 102, the scheduling center 104 determines a resource to be scheduled from the target request domain name carried in the request, and searches for the resource to be scheduled among a plurality of edge acceleration nodes available for client device resource scheduling. When the corresponding resource to be scheduled is found, node address information of a first edge acceleration node including the resource to be scheduled is fed back to the client device 102. The node address information of the first edge acceleration node may be specifically generated by integrating the target request domain name, a scheduling parameter, etc. into an HTTP 302-formatted URL by the scheduling center 104. The client device 102 directly requests the resource to be scheduled from the first edge acceleration node based on an HTTP 302 resource scheduling address in the URL.

In actual application, the scheduling center 104 may take geographic location information into consideration when searching for the resource to be scheduled. If a distance between a geographic location of the first edge acceleration node and a geographic location of the client device 102 is less than a preset distance threshold, the node address information of the first edge acceleration node is included in feedback information.

Alternatively, when there are two or more edge acceleration nodes meeting the aforementioned geographic location condition, the scheduling center 104 may feed back node address information of a first edge acceleration node with a relatively shorter distance to the client device 102.

Alternatively, the scheduling center 104 may feed back node address information of all the edge acceleration nodes meeting the geographic location condition to the client device 102, and the client device 102 selects one of the edge acceleration nodes for resource scheduling, which may be specifically determined based on the actual situation, without imposing any restrictions in this regard.

In addition, before the resource scheduling, the PCDN node starts up and logs into the scheduling center 104. The scheduling center 104 uses the PCDN node as an available node for further scheduling. Before providing data to the client device 102, the PCDN node needs to download and store the resource to be scheduled from the content delivery network (CDN).

In actual implementation, the client device 102 is further configured to send a second resource scheduling request to the scheduling center in the case of a scheduling failure, where the second resource scheduling request carries the node address information of the first edge acceleration node, the target request domain name, and the terminal address information.

Further, the scheduling center 104 is further configured to:
receive the second resource scheduling request;
determine, according to the terminal address information, a second edge acceleration node corresponding to the target request domain name and a scheduling parameter of the second edge acceleration node; and
process the target request domain name and the scheduling parameter of the second edge acceleration node according to the target scheduling protocol, and generate and return the node address information of the second edge acceleration node, where the first edge acceleration node is different from the second edge acceleration node.

Specifically, after the scheduling center 104 returns the node address information of the first edge acceleration node to the client device 102, the client device 102 may request resource scheduling from the first edge acceleration node based on the node address information. In the case of a scheduling failure, the client device 102 may further send the second resource scheduling request to the scheduling center 104. The second resource scheduling request carries the node address information of the first edge acceleration node in addition to the target request domain name and the terminal address information of the client device 102. The node address information of the first edge acceleration node is included, such that the scheduling center 104 avoids the first edge acceleration node when determining the second edge acceleration node, that is, the first edge acceleration node is different from the second edge acceleration node, thereby preventing the node address information of the first edge acceleration node from being returned to the client device 102 again, and avoiding a scheduling failure of the client device 102.

The process in which after receiving the second resource scheduling request, the scheduling center 104 determines the scheduling parameter of the second edge acceleration node, and processes the target request domain name and the scheduling parameter to generate the node address information of the second edge acceleration node is similar to the foregoing process of generating the node address information of the first edge acceleration node, which is not repeated herein.

Alternatively, the client device 102 is further configured to send a second resource scheduling request to the scheduling center in the case of a scheduling failure. The second resource scheduling request carries the target request domain name and the terminal address information.

Further, the scheduling center 104 is further configured to:
receive the second resource scheduling request, and determine a time difference between a reception time of the first resource scheduling request and a reception time of the second resource scheduling request;
retrieve node address information of the first edge acceleration node in a case that the time difference is less than or equal to a preset time threshold, and determine, according to the terminal address information, a second edge acceleration node corresponding to the target request domain name and a scheduling parameter of the second edge acceleration node; and
process the target request domain name and the scheduling parameter of the second edge acceleration node according to the target scheduling protocol, and generate and return the node address information of the second edge acceleration node, where the first edge acceleration node is different from the second edge acceleration node.

Specifically, after the scheduling center 104 returns the node address information of the first edge acceleration node to the client device 102, the client device 102 may request resource scheduling from the first edge acceleration node based on the node address information. In the case of a scheduling failure, the client device 102 may further send the second resource scheduling request to the scheduling center 104. The second resource scheduling request still carries the target request domain name and the terminal address information of the client device 102, but does not carry the node address information of the first edge acceleration node.

After the scheduling center 104 receives the second resource scheduling request, the time difference between the reception time of the first resource scheduling request and the reception time of the second resource scheduling request may be determined to avoid the first edge acceleration node when determining the second edge acceleration node, so as to avoid another scheduling failure of the client device 102 by preventing the node address information of the first edge acceleration node from being returned to the client device 102 again. If the time difference is less than or equal to the preset time threshold, it may be determined that a scheduling failure is possible when the client device 102 performs resource scheduling on the first edge acceleration node, such that the client device 102 initiates the resource scheduling request again. In this case, the scheduling center 104 may retrieve the node address information of the first edge acceleration node from historical data, and determine, according to the node address information and the terminal address information, a second edge acceleration node corresponding to the target request domain name and a scheduling parameter of the second edge acceleration node, thereby avoiding the first edge acceleration node when the second edge acceleration node is determined by using the node address information of the first edge acceleration node.

In addition, the client device 102 is further configured to:
send the first resource scheduling request to the scheduling center through a scheduling interface; and
send, through the scheduling interface, the second resource scheduling request to the scheduling center in the case of a scheduling failure, where the second resource scheduling request carries the target request domain name and the terminal address information.

The scheduling center 104 is further configured to determine, according to the terminal address information, the second edge acceleration node corresponding to the target request domain name and the scheduling parameter of the second edge acceleration node, process the target request domain name and the scheduling parameter according to the target scheduling protocol, and generate and return the node address information of the second edge acceleration node.

Specifically, the scheduling center 104 may provide the scheduling interface for the user, that is, the client device 102 may send the first resource scheduling request to the scheduling center 104 through the scheduling interface. The scheduling center 104 determines the scheduling parameter of the first edge acceleration node according to the terminal address information in the first resource scheduling request, generates the node address information of the first edge acceleration node based on the target request domain name in the first resource scheduling request and the scheduling parameter, and returns the node address information to the client device 102. The client device 102 requests resource scheduling from the first edge acceleration node based on the node address information.

In the case of a scheduling failure, the client device 102 may send the second resource scheduling request to the scheduling center 104 again through the scheduling interface, and the process in which after receiving the second resource scheduling request, the scheduling center 104 determines the scheduling parameter of the second edge acceleration node, and processes the target request domain name and the scheduling parameter to generate the node address information of the second edge acceleration node is similar to the foregoing process of generating the node address information of the first edge acceleration node, which is not repeated herein. When determining the second edge acceleration node, the scheduling center 104 may detect and avoid the first edge acceleration node to prevent the node address information of the first edge acceleration node from being returned to the client device 102 again, thereby avoiding another scheduling failure of the client device 102.

In a specific implementation, the client device 102 is further configured to schedule a video resource from the first edge acceleration node based on the node address information, and performs video playback based on the video resource.

Specifically, the client device 102 may be configured to play multimedia resources, such as audio or videos. Therefore, the client device 102 may send a video resource scheduling request to the scheduling center 104, the scheduling center 104 returns the node address information of the first edge acceleration node to the client device 102, and the client device 102 requests, based on the node address information, the video resource from the first edge acceleration node and performs video playback.

If the playback fails or gets stuck, it is generally sufficient to retry to implement re-scheduling (re-scheduling refers to requesting the foregoing scheduling interface again, and the re-scheduling process is similar to the foregoing process, in which the scheduling center can detect and avoid the edge acceleration node unavailable for playback).

An embodiment of the present application implements a resource scheduling method and system. The resource scheduling system includes a client device and a scheduling center. The client device is configured to send a first resource scheduling request to the scheduling center, where the first resource scheduling request carries a target request domain name and terminal address information of the client device. The scheduling center is configured to determine, according to the terminal address information, a first edge acceleration node corresponding to the target request domain name and a scheduling parameter of the first edge acceleration node, process the target request domain name and the scheduling parameter according to a target scheduling protocol, and generate and return node address information. The client device is further configured to acquire the node address information, perform resource scheduling on the first edge acceleration node based on the node address information, and obtain a corresponding resource scheduling result.

In this embodiment of the present application, the scheduling center can determine, according to the terminal address information of the client device, an edge acceleration node closer to the client device, then processes the terminal address information of the client device and the scheduling parameter of the edge acceleration node according to the target scheduling protocol, and generates the node address information of the edge acceleration node. The client device can directly acquire the node address information from the scheduling center without the need for an SDK, which is advantageous for reducing the amount of SDK development and improving the efficiency of resource scheduling.

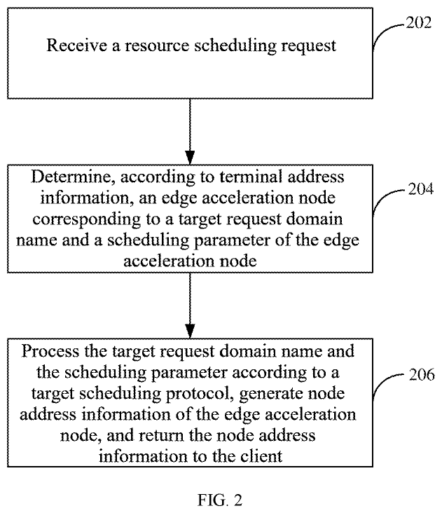

Referring to FIG. 2, FIG. 2 is a flowchart of a resource scheduling method according to an embodiment of the present application. The resource scheduling method includes following steps:

Step 202: Receive a resource scheduling request, where the resource scheduling request carries a target request domain name and terminal address information of a client device.

Step 204: Determine, according to the terminal address information, an edge acceleration node corresponding to the target request domain name and a scheduling parameter of the edge acceleration node.

Step 206: Process the target request domain name and the scheduling parameter according to a target scheduling protocol, generate node address information of the edge acceleration node, and return the node address information to the client device, where the client device performs, based on the node address information, resource scheduling on the edge acceleration node to obtain a corresponding resource scheduling result.

The resource scheduling method provided in this embodiment of the present application is applied to the scheduling center.

Specifically, the scheduling center is responsible for receiving the resource scheduling request from the client device, returning the node information of the edge acceleration node that has resources, and assisting in network address translation between the edge acceleration node and the client device.

The edge acceleration node is a PCDN node, which includes an optical modem, a home router, an over-the-top (OTT), or another device operating at the edge of the Internet. The devices run dedicated software, and are deployed and distributed by a network operator. The PCDN node is scheduled by the scheduling center to download and cache specified media data from a content delivery network into limited storage space, and provides the media data to the client device through P2P technology based on a request of a user.

After the client device sends the resource scheduling request to the scheduling center, if the client device receives the node address information of the edge acceleration node returned by the scheduling center, the client device may download a desired resource from a peer-to-peer content delivery network (PCDN) based on the node address information.

The content delivery network (CDN) is used for deploying resources to be shared, such as videos/audio/images. The CDN may be a virtual network built on an existing network.

When the client device requires a resource download, the client device sends a resource scheduling request to the scheduling center. To enable the scheduling center to correctly return information about a PCDN node that has resources to be downloaded, the resource scheduling request may include a target request domain name, as well as terminal address information of the client device and/or resource identification information of a requested resource.

The target scheduling protocol may be the HTTP 302 protocol.

The target request domain name may be used for the client device to initiate a domain name query request to a local DNS server. If the local DNS server has a cache, the local DNS server directly returns the record of the domain name to the client device. If the local DNS server does not have a cache, the local DNS server sequentially initiates iterative queries to a root domain and a com domain until the local DNS server finds a name server for a domain of the queried domain name, and then sends a query request to that name server. Since the domain name has been configured with effective CDN rules, the name server provides a CNAME record for the domain name. The CNAME record directs the query request to the scheduling center, namely, the name server responsible for a target request domain. The local DNS server continues to request the record of the domain name from the scheduling center. In this case, the scheduling center finds, based on a configuration, that the domain name is configured with HTTP 302 scheduling. According to the target scheduling protocol, a new URL is returned, where the URL includes an IP address of the given PCDN node, namely, the node address information. The client device initiates an HTTP request to the PCDN node according to a result returned by the local DNS server.

Further, after receiving a first resource scheduling request from the client device, the scheduling center determines a resource to be scheduled from the target request domain name carried in the request, and searches for the resource to be scheduled among a plurality of edge acceleration nodes available for client device resource scheduling. When the corresponding resource to be scheduled is found, node address information of a first edge acceleration node including the resource to be scheduled is fed back to the client device. The node address information of the first edge acceleration node may be specifically generated by integrating the target request domain name, a scheduling parameter, etc. into an HTTP 302-formatted URL by the scheduling center. The client device directly requests the resource to be scheduled from the first edge acceleration node based on an HTTP 302 resource scheduling address in the URL.

In actual application, the scheduling center may take geographic location information into consideration when searching for the resource to be scheduled. If a distance between a geographic location of the first edge acceleration node and a geographic location of the client device is less than a preset distance threshold, the node address information of the first edge acceleration node is included in feedback information.

Alternatively, when there are two or more edge acceleration nodes meeting the aforementioned geographic location condition, the scheduling center may feed back node address information of a first edge acceleration node with a relatively shorter distance to the client device.

Alternatively, the scheduling center may feed back node address information of all the edge acceleration nodes meeting the geographic location condition to the client device, and the client device selects one of the edge acceleration nodes for resource scheduling, which may be specifically determined based on the actual situation, without imposing any restrictions in this regard.

In addition, before the resource scheduling, the PCDN node starts up and logs into the scheduling center. The scheduling center uses the PCDN node as an available node for further scheduling. Before providing data to the client device, the PCDN node needs to download and store the resource to be scheduled from the content delivery network (CDN).

In this embodiment of the present application, the scheduling center can determine, according to the terminal address information of the client device, an edge acceleration node closer to the client device, then processes the terminal address information of the client device and the scheduling parameter of the edge acceleration node according to the target scheduling protocol, and generates the node address information of the edge acceleration node. The client device can directly acquire the node address information from the scheduling center without the need for an SDK, which is advantageous for reducing the amount of SDK development and improving the efficiency of resource scheduling.

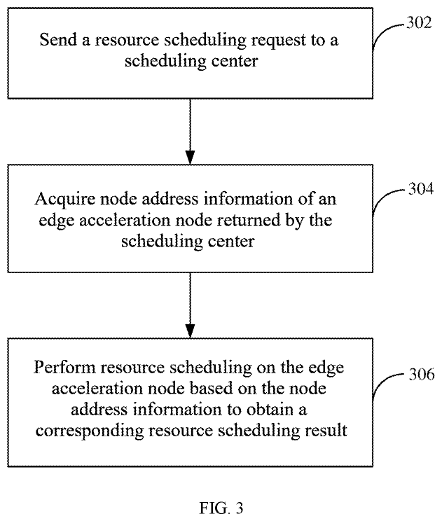

Referring to FIG. 3, FIG. 3 is a flowchart of another resource scheduling method according to an embodiment of the present application. The resource scheduling method includes following steps:

Step 302: Send a resource scheduling request to a scheduling center, where the resource scheduling request carries a target request domain name and terminal address information of a client device.

Step 304: Acquire node address information of an edge acceleration node returned by the scheduling center, where the scheduling center determines, according to the terminal address information, an edge acceleration node corresponding to the target request domain name and a scheduling parameter of the edge acceleration node, processes the target request domain name and the scheduling parameter according to a target scheduling protocol, and generates the node address information.

Step 306: Perform resource scheduling on the edge acceleration node based on the node address information to obtain a corresponding resource scheduling result.

The resource scheduling method provided in this embodiment of the present application is applied to the client device.

Specifically, the scheduling center is responsible for receiving the resource scheduling request from the client device, returning the node information of the edge acceleration node that has resources, and assisting in network address translation between the edge acceleration node and the client device.

The edge acceleration node is a PCDN node, which includes an optical modem, a home router, an over-the-top (OTT), or another device operating at the edge of the Internet. The devices run dedicated software, and are deployed and distributed by a network operator. The PCDN node is scheduled by the scheduling center to download and cache specified media data from a content delivery network into limited storage space, and provides the media data to the client device through P2P technology based on a request of a user.

After the client device sends the resource scheduling request to the scheduling center, if the client device receives the node address information of the edge acceleration node returned by the scheduling center, the client device may download a desired resource from a peer-to-peer content delivery network (PCDN) based on the node address information.

The content delivery network (CDN) is used for deploying resources to be shared, such as videos/audio/images. The CDN may be a virtual network built on an existing network.

When the client device requires a resource download, the client device sends a resource scheduling request to the scheduling center. To enable the scheduling center to correctly return information about a PCDN node that has resources to be downloaded, the resource scheduling request may include a target request domain name, as well as terminal address information of the client device and/or resource identification information of a requested resource.

The target scheduling protocol may be the HTTP 302 protocol.

The target request domain name may be used for the client device to initiate a domain name query request to a local DNS server. If the local DNS server has a cache, the local DNS server directly returns the record of the domain name to the client device. If the local DNS server does not have a cache, the local DNS server sequentially initiates iterative queries to a root domain and a com domain until the local DNS server finds a name server for a domain of the queried domain name, and then sends a query request to that name server. Since the domain name has been configured with effective CDN rules, the name server provides a CNAME record for the domain name. The CNAME record directs the query request to the scheduling center, namely, the name server responsible for a target request domain. The local DNS server continues to request the record of the domain name from the scheduling center. In this case, the scheduling center finds, based on a configuration, that the domain name is configured with HTTP 302 scheduling. According to the target scheduling protocol, a new URL is returned, where the URL includes an IP address of the given PCDN node, namely, the node address information. The client device initiates an HTTP request to the PCDN node according to a result returned by the local DNS server.

Further, after receiving a first resource scheduling request from the client device, the scheduling center determines a resource to be scheduled from the target request domain name carried in the request, and searches for the resource to be scheduled among a plurality of edge acceleration nodes available for client device resource scheduling. When the corresponding resource to be scheduled is found, node address information of a first edge acceleration node including the resource to be scheduled is fed back to the client device. The node address information of the first edge acceleration node may be specifically generated by integrating the target request domain name, a scheduling parameter, etc. into an HTTP 302-formatted URL by the scheduling center. The client device directly requests the resource to be scheduled from the first edge acceleration node based on an HTTP 302 resource scheduling address in the URL.

In actual application, the scheduling center may take geographic location information into consideration when searching for the resource to be scheduled. If a distance between a geographic location of the first edge acceleration node and a geographic location of the client device is less than a preset distance threshold, the node address information of the first edge acceleration node is included in feedback information.

Alternatively, when there are two or more edge acceleration nodes meeting the aforementioned geographic location condition, the scheduling center may feed back node address information of a first edge acceleration node with a relatively shorter distance to the client device.

Alternatively, the scheduling center may feed back node address information of all the edge acceleration nodes meeting the geographic location condition to the client device, and the client device selects one of the edge acceleration nodes for resource scheduling, which may be specifically determined based on the actual situation, without imposing any restrictions in this regard.

In addition, before the resource scheduling, the PCDN node starts up and logs into the scheduling center. The scheduling center uses the PCDN node as an available node for further scheduling. Before providing data to the client device, the PCDN node needs to download and store the resource to be scheduled from the content delivery network (CDN).

In this embodiment of the present application, the scheduling center can determine, according to the terminal address information of the client device, an edge acceleration node closer to the client device, then processes the terminal address information of the client device and the scheduling parameter of the edge acceleration node according to the target scheduling protocol, and generates the node address information of the edge acceleration node. The client device can directly acquire the node address information from the scheduling center without the need for an SDK, which is advantageous for reducing the amount of SDK development and improving the efficiency of resource scheduling.

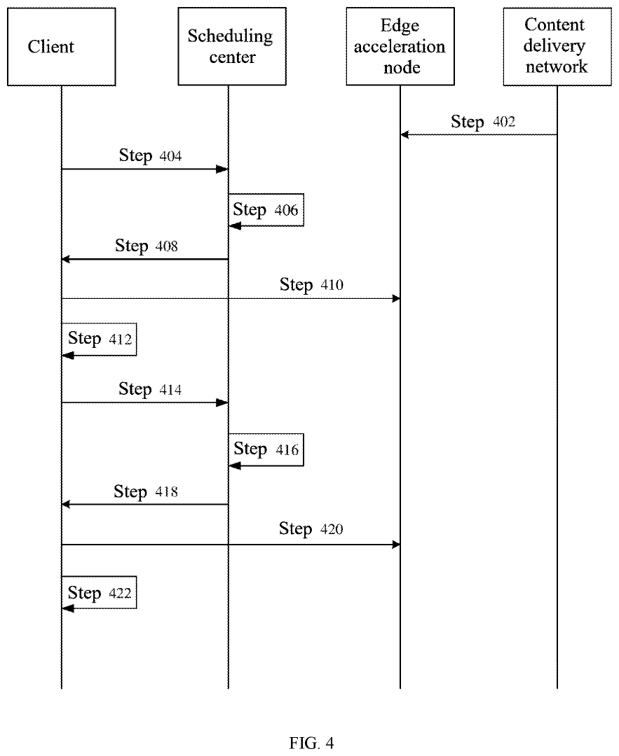

Referring to FIG. 4, the resource scheduling method is further described by using an example in which the resource scheduling method provided in this embodiment of the present application is applied to the video field. FIG. 4 is a diagram of a specific flow of a resource scheduling method applied to the video field according to an embodiment of the present application. The resource scheduling method specifically includes following steps:

Step 402: An edge acceleration node downloads and stores a video resource from a content delivery network.

Step 404: A client device sends a first video resource scheduling request to a scheduling center through a scheduling interface.

Specifically, the first video resource scheduling request carries a target request domain name and terminal address information of the client device.

Step 406: The scheduling center determines a first edge acceleration node corresponding to the target request domain name and a scheduling parameter of the first edge acceleration node according to the terminal address information, processes the target request domain name and the scheduling parameter according to the HTTP 302 protocol, and generates node address information.

Step 408: The scheduling center returns the node address information of the first edge acceleration node to the client device.

Step 410: The client device schedules a video resource from the first edge acceleration node based on the node address information of the first edge acceleration node.

Step 412: The client device performs video playback based on the video resource.

Step 414: The client device sends a second video resource scheduling request to the scheduling center through the scheduling interface in the case of a video resource scheduling failure.

Specifically, the second video resource scheduling request carries the node address information of the first edge acceleration node, the target request domain name, and the terminal address information.

Step 416: The scheduling center determines a second edge acceleration node corresponding to the target request domain name and a scheduling parameter of the second edge acceleration node according to the node address information of the first edge acceleration node and the terminal address information, processes the target request domain name and the scheduling parameter of the second edge acceleration node according to the target scheduling protocol, and generates node address information of the second edge acceleration node.

The first edge acceleration node is different from the second edge acceleration node.

Step 418: Return the node address information of the second edge acceleration node to the client device.

Step 420: The client device schedules a video resource from the second edge acceleration node based on the node address information of the second edge acceleration node.

Step 422: The client device performs video playback based on the video resource.

In this embodiment of the present application, the scheduling center can determine, according to the terminal address information of the client device, an edge acceleration node closer to the client device, then processes the terminal address information of the client device and the scheduling parameter of the edge acceleration node according to the target scheduling protocol, and generates the node address information of the edge acceleration node. The client device can directly acquire the node address information from the scheduling center without the need for an SDK, which is advantageous for reducing the amount of SDK development and improving the efficiency of video resource scheduling.

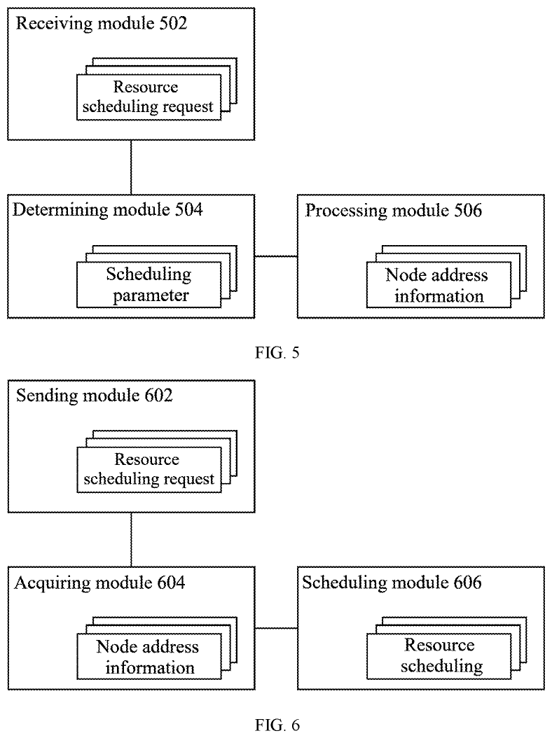

Corresponding to the above method embodiments, the present application further provides an embodiment of a resource scheduling apparatus. FIG. 5 is a schematic diagram of a structure of a resource scheduling apparatus according to an embodiment of the present application. As shown in FIG. 5, the apparatus includes:
a receiving module 502, configured to receive a resource scheduling request, where the resource scheduling request carries a target request domain name and terminal address information of a client device;
a determining module 504, configured to determine, according to the terminal address information, an edge acceleration node corresponding to the target request domain name and a scheduling parameter of the edge acceleration node; and
a processing module 506, configured to process the target request domain name and the scheduling parameter according to a target scheduling protocol, generate node address information of the edge acceleration node, and return the node address information to the client device, where the client device performs, based on the node address information, resource scheduling on the edge acceleration node to obtain a corresponding resource scheduling result.

The foregoing description is a schematic solution of the resource scheduling apparatus of this embodiment. It should be noted that the technical solution of the resource scheduling apparatus belongs to the same concept as the technical solution of the foregoing resource scheduling method. For details that are not further described in the technical solution of the resource scheduling apparatus, reference may be made to the description of the technical solution of the foregoing resource scheduling method.

Corresponding to the above method embodiments, the present application further provides an embodiment of another resource scheduling apparatus. FIG. 6 is a schematic diagram of a structure of another resource scheduling apparatus according to an embodiment of the present application. As shown in FIG. 6, the apparatus includes:
a sending module 602, configured to send a resource scheduling request to a scheduling center, where the resource scheduling request carries a target request domain name and terminal address information of a client device;
an acquiring module 604, configured to acquire node address information of an edge acceleration node returned by the scheduling center, where the scheduling center determines, according to the terminal address information, an edge acceleration node corresponding to the target request domain name and a scheduling parameter of the edge acceleration node, processes the target request domain name and the scheduling parameter according to a target scheduling protocol, and generates the node address information; and
a scheduling module 606, configured to perform resource scheduling on the edge acceleration node based on the node address information to obtain a corresponding resource scheduling result.

The foregoing description is a schematic solution of the another resource scheduling apparatus of this embodiment. It should be noted that the technical solution of the resource scheduling apparatus belongs to the same concept as the technical solution of the foregoing another resource scheduling method. For details that are not further described in the technical solution of the resource scheduling apparatus, reference may be made to the description of the technical solution of the foregoing another resource scheduling method.

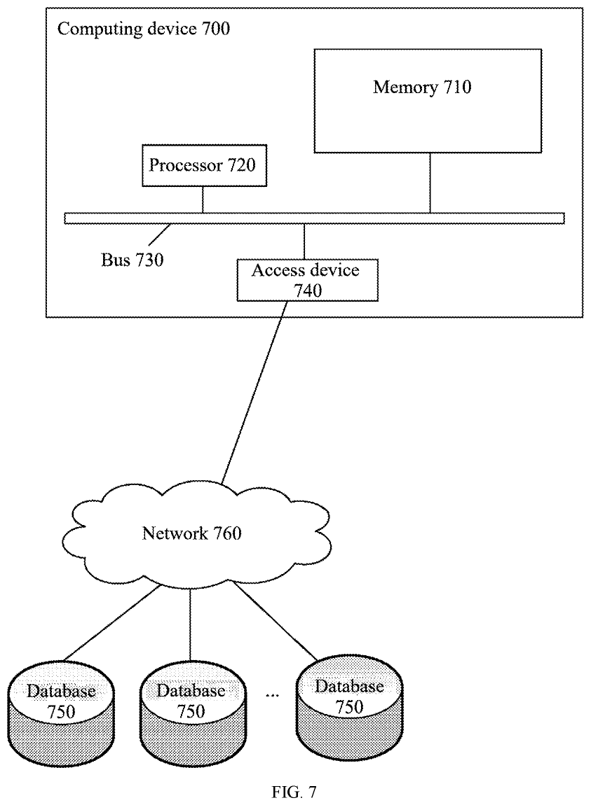

FIG. 7 is a block diagram of a structure of a computing device 700 according to an embodiment of the present application. Components of the computing device 700 include, but are not limited to, a memory 710 and a processor 720. The processor 720 is connected to the memory 710 through a bus 730, and a database 750 is configured to store data.

The computing device 700 further includes an access device 740. The access device 740 enables communication of the computing device 700 via one or more networks 760. Examples of the networks include a public switched telephone network (PSTN), a local area network (LAN), a wide area network (WAN), a personal area network (PAN), or a combination of communication networks such as the Internet. The access device 740 may include one or more of any types of wired or wireless network interface (e.g., a network interface card (NIC)), such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near-field communication (NFC) interface.

In an embodiment of the present application, the foregoing components of the computing device 700 and other components not shown in FIG. 7 may also be connected to each other, for example, through a bus. It should be understood that the block diagram of the structure of the computing device shown in FIG. 7 is merely an example, instead of limiting the scope of the present application. Those skilled in the art can add or replace other components as required.

The computing device 700 may be any type of stationary or mobile computing device, including a mobile computer or a mobile computing device (e.g., a tablet computer, a personal digital assistant, a laptop computer, a notebook computer, or a netbook), a mobile phone (e.g., a smartphone), a wearable computing device (e.g., a smartwatch or smart glasses), another type of mobile device, or a stationary computing device, such as a desktop computer or a personal computer (PC). The computing device 700 may alternatively be a mobile or stationary server.

The processor 720 is configured to execute following computer executable instructions. The processor is configured to execute the computer executable instructions. The processor, when executing the computer executable instructions, implements the steps of the resource scheduling method.

The above description is a schematic solution of the computing device of this embodiment. It should be noted that the technical solution of the computing device belongs to the same concept as the technical solution of the foregoing resource scheduling method. For details that are not further described in the technical solution of the computing device, reference may be made to the description of the technical solution of the foregoing resource scheduling method.

An embodiment of the present application further provides a computer-readable storage medium storing computer executable instructions. When the instructions are executed by a processor, the steps of the resource scheduling method are implemented.

The above description is a schematic solution of the computer-readable storage medium of this embodiment. It should be noted that the technical solution of the storage medium belongs to the same concept as the technical solution of the foregoing resource scheduling method. For details that are not further described in the technical solution of the storage medium, reference may be made to the description of the technical solution of the foregoing resource scheduling method.

An embodiment of the present application further provides a computer program. The computer program, when executed in a computer, enables the computer to perform the steps of the foregoing resource scheduling method.

The foregoing description is a schematic solution of the computer program of this embodiment of the present application. It should be noted that the technical solution of the computer program belongs to the same concept as the technical solution of the foregoing resource scheduling method. For details that are not further described in the technical solution of the computer program, reference may be made to the description of the technical solution of the foregoing resource scheduling method.

Specific embodiments of the present application are described above. Other embodiments are within the scope of the appended claims. In some cases, the actions or steps recited in the claims can be performed in an order different from that in the embodiments, and can still achieve desired results. In addition, the processes depicted in the figures are not necessarily required to be shown in a particular or sequential order, to achieve desired results. In some implementations, multi-task processing and parallel processing are also possible or may be advantageous.

The computer instructions include computer program code, which may be in a source code form, an object code form, an executable file form, some intermediate forms, etc. The computer-readable medium may include any entity or apparatus that can carry the computer program code, such as a recording medium, a USB flash drive, a removable hard disk, a magnetic disk, an optical disc, a computer memory, a read-only memory (ROM), a random access memory (RAM), an electrical carrier signal, a telecommunications signal, and a software distribution medium. It should be noted that the content included in the computer-readable medium can be appropriately added or deleted depending on requirements of the legislation and patent practice in a jurisdiction. For example, in some jurisdictions, according to the legislation and patent practice, the computer-readable medium does not include the electrical carrier signal and the telecommunications signal.

It should be noted that, for ease of description, the foregoing method embodiments are described as a series of action combinations. However, those skilled in the art should understand that the embodiments of the present application are not limited to the described action order, because according to the embodiments of the present application, some steps may be performed in another order or simultaneously. Moreover, those skilled in the art should also understand that the embodiments described in this specification are all preferred embodiments, and the involved actions and modules are not necessarily required by the embodiments of the present application.

In the above embodiments, the embodiments are described with different emphases, and for a part that is not detailed in an embodiment, references can be made to the related description of the other embodiments.

The preferred embodiments of the present application disclosed above are merely provided to help illustrate the present application. Optional embodiments are not intended to exhaust all details, nor do they limit the invention to only the described specific implementations. Apparently, many modifications and variations may be made in light of the content of the embodiments of the present application. In the present application, these embodiments are selected and specifically described to provide a better explanation of the principles and practical applications of the embodiments of the present application, so that those skilled in the art can well understand and utilize the present application. The present application should be defined only by the claims, and the full scope and equivalents thereof.

1. A resource scheduling method, applied to a scheduling center, comprising:
receiving a first resource scheduling request from a client device, wherein the first resource scheduling request carries a target request domain name and terminal address information of the client device;
determining, based on the terminal address information, a first edge acceleration node corresponding to the target request domain name and a scheduling parameter of the first edge acceleration node;
generating node address information of the first edge acceleration node based on processing the target request domain name and the scheduling parameter of the first edge acceleration node according to a target scheduling protocol; and
returning the node address information of the first edge acceleration node to the client device, wherein the client device performs resource scheduling on the first edge acceleration node to obtain a corresponding resource scheduling result based on the node address information.

2. A resource scheduling system, comprising:
a client device and a scheduling center,
wherein the client device is configured to send a first resource scheduling request to the scheduling center, wherein the first resource scheduling request carries a target request domain name and terminal address information of the client device;
the scheduling center is configured to determine, based on the terminal address information, a first edge acceleration node corresponding to the target request domain name and a scheduling parameter of the first edge acceleration node, generate node address information of the first edge acceleration node based on processing the target request domain name and the scheduling parameter according to a target scheduling protocol, and return the node address information of the first edge acceleration node to the client device; and
the client device is further configured to acquire the node address information of the first edge acceleration node and perform resource scheduling on the first edge acceleration node based on the node address information to obtain a corresponding resource scheduling result.

3. The resource scheduling system according to claim 2, wherein the client device is further configured to send a second resource scheduling request to the scheduling center when a scheduling failure occurs, and the second resource scheduling request carries the node address information of the first edge acceleration node, the target request domain name, and the terminal address information.

4. The resource scheduling system according to claim 3, wherein the scheduling center is further configured to:
receive the second resource scheduling request from the client device;
determine, based on the terminal address information, a second edge acceleration node corresponding to the target request domain name and a scheduling parameter of the second edge acceleration node;
generate node address information of the second edge acceleration node based on processing the target request domain name and the scheduling parameter of the second edge acceleration node according to the target scheduling protocol; and
return the node address information of the second edge acceleration node to the client device, wherein the first edge acceleration node is different from the second edge acceleration node.

5. The resource scheduling system according to claim 2, wherein the client device is further configured to send a second resource scheduling request to the scheduling center when a scheduling failure occurs, and the second resource scheduling request carries the target request domain name and the terminal address information.

6. The resource scheduling system according to claim 5, wherein the scheduling center is further configured to:
receive the second resource scheduling request from the client device,
determine a time difference between a time of receiving the first resource scheduling request and a time of receiving the second resource scheduling request;
retrieve the node address information of the first edge acceleration node in response to determining that the time difference is less than or equal to a preset time threshold,
determine, based on the terminal address information, a second edge acceleration node corresponding to the target request domain name and a scheduling parameter of the second edge acceleration node;
generate node address information of the second edge acceleration node based on processing the target request domain name and the scheduling parameter of the second edge acceleration node according to the target scheduling protocol; and
return the node address information of the second edge acceleration node to the client device, wherein the first edge acceleration node is different from the second edge acceleration node.

7. The resource scheduling system according to claim 2, wherein the client device is further configured to:
send the first resource scheduling request to the scheduling center through a scheduling interface; and
send, through the scheduling interface, a second resource scheduling request to the scheduling center when a scheduling failure occurs, wherein the second resource scheduling request carries the target request domain name and the terminal address information, and
the scheduling center is further configured to determine, based on the terminal address information, the second edge acceleration node corresponding to the target request domain name and a scheduling parameter of the second edge acceleration node, generate node address information of the second edge acceleration node based on processing the target request domain name and the scheduling parameter according to the target scheduling protocol, and return the node address information of the second edge acceleration node to the client device.

8. The resource scheduling system according to claim 2, wherein the client device is further configured to schedule a video resource from the first edge acceleration node based on the node address information of the first edge acceleration node, and to perform video playback based on the video resource.

9. A resource scheduling method, applied to a client device, comprising:
sending a first resource scheduling request to a scheduling center, wherein the first resource scheduling request carries a target request domain name and terminal address information of the client device;
acquiring node address information of a first edge acceleration node returned by the scheduling center, wherein the scheduling center determines, based on the terminal address information, the first edge acceleration node corresponding to the target request domain name and a scheduling parameter of the first edge acceleration node, and generates node address information of the first edge acceleration node based on processing the target request domain name and the scheduling parameter of the first edge acceleration node according to a target scheduling protocol; and
performing resource scheduling on the first edge acceleration node based on the node address information of the first edge acceleration node to obtain a corresponding resource scheduling result.

10.-13. (canceled)

14. The resource scheduling method according to claim 1, further comprising:
receiving a second resource scheduling request from the client device, wherein the second resource scheduling request is generated by the client device when a scheduling failure occurs, and wherein the second resource scheduling request carries the node address information of the first edge acceleration node, the target request domain name, and the terminal address information;
determining, based on the terminal address information, a second edge acceleration node corresponding to the target request domain name and a scheduling parameter of the second edge acceleration node;
generating node address information of the second edge acceleration node based on processing the target request domain name and the scheduling parameter of the second edge acceleration node according to the target scheduling protocol; and
returning the node address information of the second edge acceleration node to the client device, wherein the first edge acceleration node is different from the second edge acceleration node.

15. The resource scheduling method according to claim 1, further comprising:
receiving a second resource scheduling request from the client device, wherein the second resource scheduling request is generated by the client device when a scheduling failure occurs, and wherein the second resource scheduling request carries the target request domain name and the terminal address information;
determining a time difference between a time of receiving the first resource scheduling request and a time of receiving the second resource scheduling request;
retrieving the node address information of the first edge acceleration node in response to determining that the time difference is less than or equal to a preset time threshold,
determining, based on the terminal address information, a second edge acceleration node corresponding to the target request domain name and a scheduling parameter of the second edge acceleration node;
generating node address information of the second edge acceleration node based on processing the target request domain name and the scheduling parameter of the second edge acceleration node according to the target scheduling protocol; and
returning the node address information of the second edge acceleration node to the client device, wherein the first edge acceleration node is different from the second edge acceleration node.

16. The resource scheduling method according to claim 9, further comprising:
sending the first resource scheduling request to the scheduling center through a scheduling interface;
generating a second resource scheduling request when a scheduling failure occurs; and
sending the second resource scheduling request to the scheduling center through the scheduling interface, wherein the second resource scheduling request carries the node address information of the first edge acceleration node, the target request domain name, and the terminal address information.

17. The resource scheduling method according to claim 9, further comprising:
scheduling a video resource from the first edge acceleration node based on the node address information of the first edge acceleration node; and
performing video playback based on the video resource.
